(19) United States
(12) Patent Application Publication
(10) Pub. No.: US 2026/0031911 A1
(43) Pub. Date: Jan. 29, 2026

(54) REMOTE OPTICAL PATH SWITCHING NODE AND REMOVE OPTICAL PATH SWITCHING METHOD

(71) Applicant: Nippon Telegraph and Telephone Corporation, Tokyo (JP)

(72) Inventors: Kazuhide NAKAE, Musashino-shi, Tokyo (JP); Chisato Fukai, Musashino-shi, Tokyo (JP); Kazunori Katayama, Musashino-shi, Tokyo (JP); Hiroshi WATANABE, Musashino-shi, Tokyo (JP); Tomohiro Kawano, Musashino-shi, Tokyo (JP)

(21) Appl. No.: 18/996,677

(22) PCT Filed: Aug. 5, 2022
(86) PCT No.: PCT/JP2022/030146

§ 371 Date: Jan. 17, 2025

(51) Int. Cl. H04B 10/291; H04B 10/80

(52) U.S. Cl. CPC H04B 10/291; H04B 10/80

(57) ABSTRACT

A remote optical path switching node 10 disposed at a connection point between optical fibers includes an optical switch unit 11 that switches connection of core wires of optical fibers connected to ports, a photoelectric conversion element 13 that photoelectrically converts feeding light into electric energy, an optical power supply capacitor 14 that stores the electric energy obtained by performing the photoelectric conversion by the photoelectric conversion element 13, a manhole power generation capacitor 15 that stores electric energy supplied from a power generation unit 30, and a remote control unit 16 that supplies electric energy from at least one of an optical power supply capacitor 14 and the manhole power generation capacitor 15 to the optical switch unit 11 and controls the optical switch unit 11 to switch connection of the core wires between the optical fibers.

### TECHNICAL FIELD

The present invention relates to a remote optical path switching node and a remote optical path switching method.

### BACKGROUND ART

In an access network connecting an accommodation station and a communication terminal on a user side by an optical fiber, optical path switching of an optical path is performed at a fixed frequency in installation work and maintenance work. In a method in which an operator enters a manhole and opens a housing of a connection point to switch a core wire of an optical fiber, there is a problem that it takes time to prepare for an operator and perform an operation of switching an optical path.

Consequently, it has been studied to configure an access network with a multi-stage loop type wiring and a remote optical path switching node. The multi-stage loop type wiring is configured such that a plurality of loop wirings are connected in multiple stages. The remote optical path switching node is disposed at a connection point between an upper loop and a lower loop of the multi-stage loop type wiring, and connection of optical fiber core wires between the loops can be switched by a remote operation from an accommodation station. By realizing remote optical path switching using the remote optical path switching node, a working time can be shortened.

However, since the remote optical path switching node is assumed to be installed in a manhole, it is difficult to secure a power supply from the outside. In NPL 1 and NPL 2, there has been proposed a remote optical path switching node which photoelectrically converts supplied light transmitted from an accommodation station to store electric energy in a capacitor, and drives each part of the remote optical path switching node by the electric energy stored in the capacitor.

### CITATION LIST

### Non Patent Literature

[NPL 1] Tomohiro Kawano, Tatsuya Fujimoto, Kazuhide Nakae, Hiroshi Watanabe, Kazunori Katayama, “A study on a remote optical path switching node for a future optical access network”, 2021 IEICE General Conference, B-13-16, 2021

[NPL 2] Tomohiro Kawano, Tetsuya Manabe, Akihiro Kuroda, Kazuhide Nakae, Hiroshi Watanabe, Kazunori Katayama, “A study on a series connection method of a remote optical path switching node”, 2022 IEICE General Conference, B-13-28, 2022

### SUMMARY OF INVENTION

### Technical Problem

The remote optical path switching nodes of NPL 1 and NPL 2 have a problem that there is a concern that respective parts of the remote optical path switching node may not be able to be driven because a capacitor cannot be charged with supplied light through an optical power supply fiber due to system problems or the like.

The present invention has been made in view of the above- described circumstances, and an object thereof is to operate a remote optical path switching node more stably.

### Solution to Problem

A remote optical path switching node according to an embodiment of the present invention is a remote optical path switching node disposed at a connection point between optical fibers, the remote optical path switching node including an optical switch unit configured to switch connection of core wires of optical fibers connected to ports, a photoelectric conversion element configured to photoelectrically convert feeding light into electric energy, a first capacitor configured to store the electric energy, a second capacitor configured to store electric energy supplied from an external power generation device, and a remote control unit configured to supply electric energy from at least one of the first capacitor and the second capacitor to the optical switch unit, and control the optical switch unit to switch connection of the core wires of the optical fibers.

A remote optical path switching method according to an embodiment of the present invention is a remote optical path switching method executed by a remote optical path switching node disposed at a connection point between optical fibers, in which the remote optical path switching node includes a first capacitor for storing electric energy obtained by photoelectrically converting feeding light and a second capacitor for storing electric energy supplied from an external power generation device, and the remote optical path switching node confirms a power storage amount of electric energy of the second capacitor when electric energy of the first capacitor is not able to be used, and switches connection of core wires of the optical fibers by using the electric energy of the second capacitor when the power storage amount is equal to or greater than a threshold value.

### Advantageous Effects of Invention

According to the present invention, a remote optical path switching node can be operated more stably.

### BRIEF DESCRIPTION OF DRAWINGS

FIG. 1 is a diagram showing an example of a configuration of a remote optical path switching node.

FIG. 2 is a flowchart showing an example of a flow of power supply processing during optical path switching.

FIG. 3 is a flowchart showing an example of a flow of power supply processing during optical path switching.

FIG. 4 is a diagram showing an example of a configuration of a network using a multi-stage loop type wiring.

FIG. 5 is diagram for describing an example of an optical path switching procedure.

FIG. 6 is a diagram for describing an example of an optical path switching procedure.

FIG. 7 is a diagram showing an example of a configuration of a remote optical path switching node.

### DESCRIPTION OF EMBODIMENTS

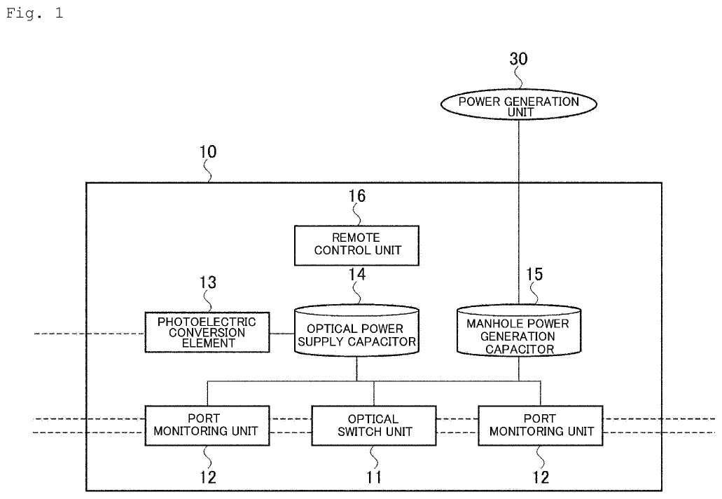

An example of a configuration of a remote optical path switching node 10 according to the present embodiment will be described with reference to FIG. 1. The remote optical path switching node 10 is a device that is disposed, for example, in a manhole at a connection point between loops of a multi-stage loop type wiring and switches connection of coated optical fibers between the loops. The remote optical path switching node 10 operates using electric energy obtained by a power generation unit 30 installed on a manhole cover in addition to electric energy obtained by photoelectrically converting feeding light transmitted from an accommodation station.

The remote optical path switching node 10 shown in FIG. 1 includes an optical switch unit 11, a port monitoring unit 12, a photoelectric conversion element 13, an optical power supply capacitor 14 (first capacitor), a manhole power generation capacitor 15 (second capacitor), and a remote control unit 16.

The coated optical fibers of the loops are connected to the optical switch unit 11 through a port monitoring unit 12. The coated optical fibers are connected to ports provided in the remote optical path switching node 10. The optical switch unit 11 switches connection of coated optical fibers between the loops in response to an instruction received from the accommodation station. Specifically, the optical switch unit 11 physically moves a member in the optical switch unit 11 to connect the ports so that light incident from the port is emitted to a port which is a connection destination. By connecting the ports to each other by the optical switch unit 11, the coated optical fibers between the loops are connected, and optical paths are connected.

The port monitoring unit 12 measures an optical power of the coated optical fiber in each of the ports to which the coated optical fibers are connected, and ascertains the connection between the ports. Then, the port monitoring unit 12 generates connection information indicating the ascertained connection between the ports.

At the time of switching an optical path, the optical switch unit 11 and the port monitoring unit 12 are operated by power supplied from at least one of the optical power supply capacitor 14 and the manhole power generation capacitor 15.

An optical fiber for transmitting feeding light and control light transmitted from the accommodation station is connected to the photoelectric conversion element 13. The photoelectric conversion element 13 receives the feeding light transmitted from the accommodation station, photoelectrically converts light energy of the feeding light into electric energy, and stores the electric energy in the optical power supply capacitor 14. In addition, another photoelectric conversion element (not shown) receives the control light transmitted from the accommodation station, converts the control light into an electric signal, and transmits the electric signal to the remote control unit 16, thereby notifying the remote control unit 16 of a remote instruction from the accommodation station.

The optical power supply capacitor 14 stores electric energy obtained by converting the feeding light, and drives the optical switch unit 11, the port monitoring unit 12, and the remote control unit 16 by the stored electric energy.

The manhole power generation capacitor 15 is connected to the power generation unit 30 through an electric wiring. The manhole power generation capacitor 15 stores electric energy generated by the power generation unit 30, and drives the optical switch unit 11, the port monitoring unit 12, and the remote control unit 16 with the stored electric energy.

The remote control unit 16 is a control unit that controls the remote optical path switching node 10 in response to a remote instruction using the control light transmitted from the accommodation station. For example, the remote control unit 16 controls the optical switch unit 11 to connect core wires between the loops, and transmits connection information between the coated optical fibers ascertained by the port monitoring unit 12 to the accommodation station. In addition, the remote control unit 16 monitors a power storage amount of the optical power supply capacitor 14 and the manhole power generation capacitor 15, and controls power supply from the optical power supply capacitor 14 and the manhole power generation capacitor 15 to the optical switch unit 11 and the port monitoring unit 12. A micro-processing unit (MPU) equipped with a processor can be used for the remote control unit 16.

The power generation unit 30 is a device that is installed, for example, on a manhole cover, and generates power by using renewable energy such as sunlight, heat, or vibration. Examples 1 to 3 of the power generation unit 30 installed on the manhole cover will be described below.

Example 1 is an example in which the power generation unit 30 generates power by using light energy of sunlight. A solar panel is installed on the upper side of the manhole cover as the power generation unit 30, and power generated by photoelectric conversion by absorbing light energy of the sun is stored in the manhole power generation capacitor 15 through electric wirings. When the amount of power generated by a general solar panel is equivalent to the size of a manhole cover (0.6 m²), power of several hundreds of tens W can be obtained even when power conversion efficiency of solar power generation is considered to be 20%, and thus power for operating the remote optical path switching node 10 can be sufficiently secured. A surface layer portion of the solar panel may be covered with a material excellent in pressure resistance and impact resistance.

Example 2 is an example in which the power generation unit 30 generates power by using thermal energy of the sun. A thermoelectric element is installed on the manhole cover as the power generation unit 30, and power generated by a thermoelectric effect using a temperature difference between an upper side of the manhole cover (the outside of the manhole) and a lower side of the manhole cover (the inside of the manhole) is stored in the manhole power generation capacitor 15 through electric wirings. Wen the amount of power generated is equivalent to the size of a manhole cover of a general thermoelectric element, power of several W can be obtained even when power conversion efficiency of a thermoelectric element is considered to be 5%, and thus power for operating the remote optical path switching node 10 can be sufficiently secured. A surface layer unit of the thermoelectric element may be covered with a material excellent in pressure resistance and impact resistance.

Example 3 is an example in which power is generated by using energy generated by vibration. A vibration power generation mechanism for generating power by effects such as electromagnetic induction, electrostatic induction, reverse magnetostriction effect, or a piezoelectric effect by utilizing vibration transmitted to a manhole cover by using vibration transmitted to a manhole cover by traveling of an automobile or the like is installed on the manhole cover as the power generation unit 30. The vibration power generation mechanism is not limited to the manhole cover, but may be installed in a place where vibration is likely to occur in a manhole or in a peripheral part.

In any of the cases of Examples 1 to 3, it is preferable to adopt a configuration in which electric wirings are not interfered (pulled) at the time of opening the manhole cover.

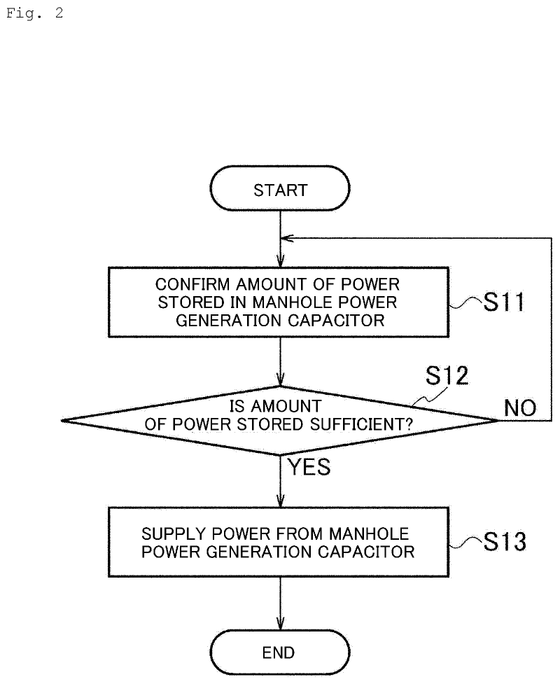

Next, an example of power supply processing in a case where electric energy of the optical power supply capacitor 14 cannot be used will be described with reference to a flowchart of FIG. 2. When power is not stored in the optical power supply capacitor 14 due to system problems, power is supplied from the manhole power generation capacitor 15 in accordance with to the flowchart of FIG. 2.

Specifically, in step S11, the remote control unit 16 confirms a power storage amount of the manhole power generation capacitor 15.

In step S12, the remote control unit 16 determines whether a power storage amount of the manhole power generation capacitor 15 is sufficient.

When the power storage amount is sufficient, the remote control unit 16 supplies power from the manhole power generation capacitor 15 to the optical switch unit 11 and the port monitoring unit 12 in step S13.

When the power storage amount is not sufficient, the remote control unit 16 waits for power to be stored in the manhole power generation capacitor 15.

Through the above-described processing, even when electric energy of the optical power supply capacitor 14 cannot be used, an optical path can be switched by using the manhole power generation capacitor 15.

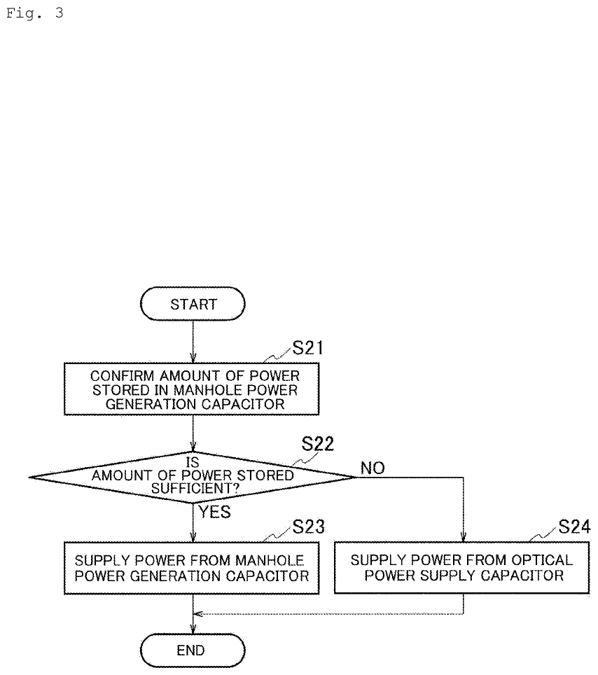

Next, an example of power supply processing in which electric energy of the manhole power generation capacitor 15 is preferentially used will be described with reference to a flowchart of FIG. 3.

In step S21, the remote control unit 16 confirms a power storage amount of the manhole power generation capacitor 15.

In step S22, the remote control unit 16 determines whether a power storage amount of the manhole power generation capacitor 15 reaches the amount of power stored with which the optical switch unit 11 and the port monitoring unit 12 can operate.

When the power storage amount is sufficient, the remote control unit 16 supplies power from the manhole power generation capacitor 15 to the optical switch unit 11 and the port monitoring unit 12 in step S23.

When the power storage amount is not sufficient, the remote control unit 16 supplies power from the optical power supply capacitor 14 to the optical switch unit 11 and the port monitoring unit 12 in step S24.

Both the optical power supply capacitor 14 and the manhole power generation capacitor 15 may supply power to the optical switch unit 11 and the port monitoring unit 12.

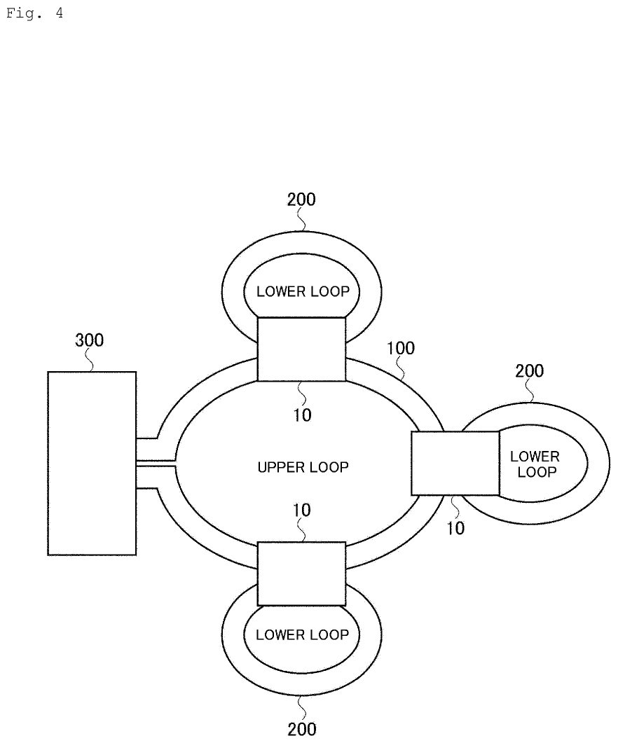

Next, a network of a multi-stage loop type wiring will be described with reference to FIG. 4.

In the multi-stage loop type wiring, one or more lower loops 200 are connected to an upper loop 100 connected to an accommodation station 300. The remote optical path switching node 10 is disposed at a connection point between the upper loop 100 and the lower loop 200. The upper loop 100 and the lower loop 200 are constituted by optical fibers having a plurality of core wires. By connecting a coated optical fiber of the upper loop 100 and a coated optical fiber of the lower loop 200 in the remote optical path switching node 10, an optical path is connected between a communication device on the lower loop 200 and a communication device in the accommodation station. An optical path can be connected between communication devices on different lower loops 200 through the upper loop 100. The upper loop 100 is provided with an optical fiber for supplying feeding light to each of the remote optical path switching nodes 10. The optical fiber can also be used for transmission of control light.

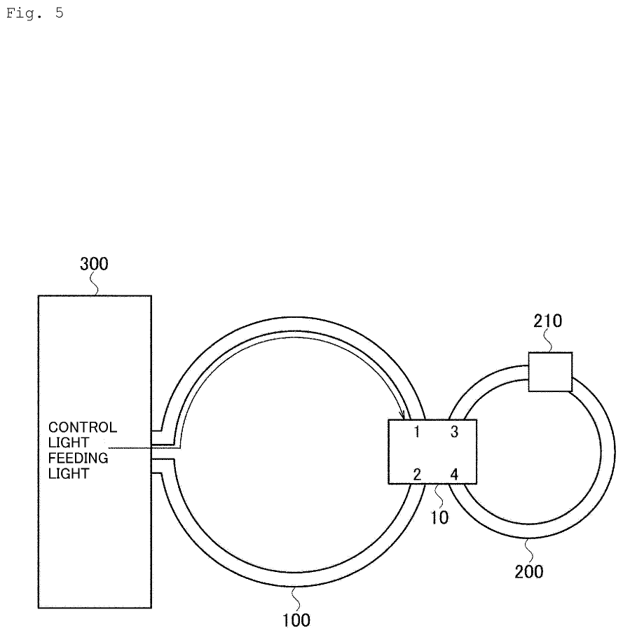

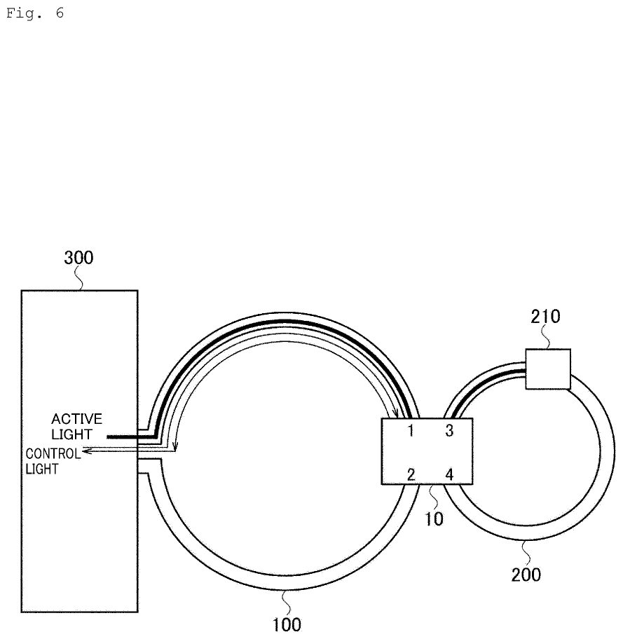

Next, an optical path switching procedure will be described with reference to FIGS. 5 and 6. In an example shown in FIGS. 5 and 6, an optical path is connected between the accommodation station 300 and a communication device 210 on the lower loop 200. The communication device 210 is, for example, a radio base station. It is assumed that the coated optical fiber of the upper loop 100 is connected to a port 1 and a port 2 of the remote optical path switching node 10, and the coated optical fiber of the lower loop 200 is connected to a port 3 and a port 4 of the remote optical path switching node 10.

First, as shown in FIG. 5, the accommodation station 300 transmits control light for instructing the remote optical path switching node 10 to connect the port 1 and the port 3. The remote optical path switching node 10, which has received the instruction, controls the optical switch unit 11 to connect the port 1 and the port 3. When the port 1 and the port 3 of the remote optical path switching node 10 are connected to each other, an optical path is connected between the accommodated station and the communication device 210 through the port 1 and the port 3, as shown in FIG. 6.

After the switching of the optical path is completed in the remote optical path switching node 10, the accommodation station 300 transmits control light for instructing the remote optical path switching node 10 to acquire connection information.

The remote optical path switching node 10 controls the port monitoring unit 12, confirms the connection between the port 1 and the port 3, and returns the connection information to the accommodation station 300. The connection information may be confirmed by an optical test. For example, the control light transmitted from the accommodation station 300 is used for response to the accommodation station 300, connection information is superimposed on the control light and transmitted.

When the accommodation station 300 confirms the connection information, the accommodation station 300 starts to use the optical path between the accommodation station 300 and the communication device 210.

When the multi-stage loop type wiring and the remote optical path switching node are used, the optical path can be easily switched when a failure occurs after the use thereof is started. For example, when a failure occurs between the port 3 and the communication device 210, the accommodation station 300 transmits control light for instructing the remote optical path switching node 10 to connect the port 1 and the port 4. When the remote optical path switching node 10 receives the control light, the remote optical path switching node 10 connects the port 1 and the port 4. Thereby, the optical path is connected between the accommodation station and the communication device 210 through the port 1 and the port 4.

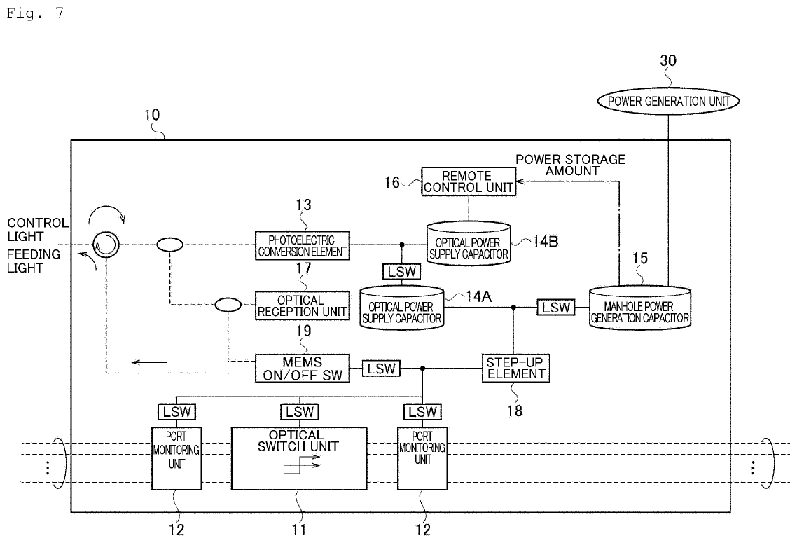

Next, an example of the remote optical path switching node will be described with reference to FIG. 7. The remote optical path switching node 10 in FIG. 7 has a configuration in which the manhole power generation capacitor 15 is added to the remote optical path switching node disclosed in NPL 2. In FIG. 7, power lines for supplying power to units are indicated by solid lines, and optical fibers are indicated by broken lines. Components having the same functions as the units of the remote optical path switching node 10 shown in FIG. 1 are denoted by the same reference numerals.

An optical fiber of each loop is connected to the optical switch unit 11 through the port monitoring unit 12.

An optical fiber for transmitting feeding light and control light is connected to the photoelectric conversion element 13, an optical reception unit 17, and a Micro Electro Mechanical Systems (MEMS) switch 19. The feeding light is incident on the photoelectric conversion element 13, and the control light is incident on the optical reception unit 17 and the MEMS switch 19. The feeding light is photoelectrically converted by the photoelectric conversion element 13, and electric energy is stored in optical power supply capacitors 14A and 14B (first capacitors). The remote optical path switching node 10 in FIG. 7 is provided with two systems of optical power supply capacitors, that is, an optical power supply capacitor 14A for supplying power to the optical switch unit 11 and the port monitoring unit 12 and an optical power supply capacitor 14B for supplying power to the remote control unit 16. When the manhole power generation capacitor 15 is also added, the remote optical path switching node 10 in FIG. 7 is provided with three power supplies.

The control light is received by the optical reception unit 17, converted into an electric signal, and transmitted to the remote control unit 16. The remote control unit 16 operates the remote optical path switching node 10 in accordance with the control light converted into the electric signal.

The MEMS switch 19 is used to transmit data from the remote optical path switching node 10 to the accommodation station. The remote control unit 16 controls reflection of the control light by switching between turn-on and turn-off of the MEMS switch 19, and superimposes information to be transmitted on the control light.

The power lines connect the capacitors 14A, 14B, and 15 to the units of the remote optical path switching node 10, and supplies power from the capacitors 14A, 14B, and 15 to the units. A load switch (LSW) is disposed on the power line. The remote control unit 16 controls the LSW to control power supply to each unit. For example, when an optical path is switched, the remote control unit 16 turns on the LSW connected to the optical switch unit 11 to supply power to the optical switch unit 11.

The power generation unit 30 disposed on the manhole cover and the manhole power generation capacitor 15 are connected by power lines, and power generated by the power generation unit 30 is stored in the manhole power generation capacitor 15. A power storage amount of the manhole power generation capacitor 15 is monitored by the remote control unit 16. When sufficient power is stored in the manhole power generation capacitor 15, the remote control unit 16 turns on the LSW connected to the manhole power generation capacitor 15 to connect the manhole power generation capacitor 15 and a step-up element 18, and supplies power from the manhole power generation capacitor 15 to each unit.

As described above, the remote optical path switching node 10 disposed at a connection point between optical fibers according to the present embodiment includes the optical switch unit 11 that switches connection of core wires of optical fibers connected to ports, the photoelectric conversion element 13 that photoelectrically converts feeding light into electric energy, the optical power supply capacitor 14 that stores the electric energy obtained by performing the photoelectric conversion by the photoelectric conversion element 13, the manhole power generation capacitor 15 that stores electric energy supplied from the power generation unit 30, and the remote control unit 16 that supplies electric energy from at least one of the optical power supply capacitor 14 and the manhole power generation capacitor 15 to the optical switch unit 11 and controls the optical switch unit 11 to switch connection of the core wires between the optical fibers. Thereby, even when electric energy of the optical power supply capacitor 14 cannot be used due to system problems, power can be supplied from the manhole power generation capacitor 15 to the optical switch unit 11. As a result, the remote optical path switching node 10 can be operated more stably.

### Reference Signs List

10 Remote optical path switching node
11 Optical switch unit
12 Port monitoring unit
13 Photoelectric conversion element
14, 14A, 14B Optical power supply capacitor (first capacitor)
15 Manhole power generation capacitor (second capacitor)
16 Remote control unit
17 Optical reception unit
18 Step-up element
19 MEMS switch
30 Power generation unit

1. A remote optical path switching node disposed at a connection point between optical fibers, the remote optical path switching node comprising:
an optical switch unit configured to switch connection of core wires of optical fibers connected to ports;
a photoelectric conversion element configured to photoelectrically convert feeding light into electric energy;
a first capacitor configured to store the electric energy;
a second capacitor configured to store electric energy supplied from an external power generation device; and
a remote control unit, including one or more processors, configured to supply electric energy from at least one of the first capacitor and the second capacitor to the optical switch unit, and control the optical switch unit to switch connection of the core wires of the optical fibers.

2. The remote optical path switching node according to claim 1, further comprising:
a port monitoring unit configured to monitor connection between the ports,
wherein
the remote control unit is configured to transmit connection information indicating connection between the ports.

3. The remote optical path switching node according to claim 1, wherein
the remote optical path switching node is disposed in a manhole, and
the power generation device is a solar panel disposed on a manhole cover.

4. The remote optical path switching node according to claim 1, wherein
the remote optical path switching node is disposed in a manhole, and
the power generation device is a thermoelectric element disposed on a manhole cover.

5. The remote optical path switching node according to claim 1, wherein
the remote optical path switching node is disposed in a manhole, and
the power generation device generates power by using vibration of a manhole cover.

6. A remote optical path switching method executed by a remote optical path switching node disposed at a connection point between optical fibers, wherein
the remote optical path switching node includes a first capacitor for storing electric energy obtained by photoelectrically converting feeding light and a second capacitor for storing electric energy supplied from an external power generation device, and
wherein the remote optical path switching method comprises, by the remote optical path switching node,
confirming a power storage amount of electric energy of the second capacitor when electric energy of the first capacitor is not able to be used, and
switching connection of core wires of the optical fibers by using the electric energy of the second capacitor when the power storage amount is equal to or greater than a threshold value.

7. The remote optical path switching method according to claim 6, further comprising:
monitoring connection between the ports; and
transmitting connection information indicating connection between the ports.

8. The remote optical path switching method according to claim 6, wherein
the remote optical path switching node is disposed in a manhole, and
the power generation device is a solar panel disposed on a manhole cover.

9. The remote optical path switching method according to claim 6, wherein
the remote optical path switching node is disposed in a manhole, and
the power generation device is a thermoelectric element disposed on a manhole cover.

10. The remote optical path switching method according to claim 6, wherein
the remote optical path switching node is disposed in a manhole, and
the power generation device generates power by using vibration of a manhole cover.
